(19) United States
(12) Patent Application Publication
(10) Pub. No.: US 2022/0146333 A1
(43) Pub. Date: May 12, 2022

(54) FINE-GRAINED INDOOR TEMPERATURE MEASUREMENTS USING SMART DEVICES FOR IMPROVED INDOOR CLIMATE AND ENERGY SAVINGS

(71) Applicant: NEC Laboratories Europe GmbH, Heidelberg (DE)

(72) Inventors: Jonathan Fuerst, Heidelberg (DE); Mauricio Fadel Argerich, Heidelberg (DE)

(21) Appl. No.: 17/182,272

(22) Filed: Feb. 23, 2021

Related U.S. Application Data
(60) Provisional application No. 63/112,182, filed on Nov. 11, 2020.

(51) Int. Cl. G01K 13/02; G05B 15/02

(52) U.S. Cl. CPC G01K 13/02; G05B 15/02; G01K 2201/00; G05B 2219/2614; G01K 2207/00

(57) ABSTRACT

A method for fine-grained indoor temperature measurement includes receiving sensor data and activity telemetry data from one or more smart devices. Feature transformation is performed on the sensor data and activity telemetry data to a common latent feature space so as to reduce an influence of a domain of the one or more smart devices. Latent features resulting from the feature transformation on the sensor data and activity telemetry data is input into a machine learning model trained with features of the latent feature space and labeled ambient temperatures to predict an ambient temperature at a location of the one or more smart devices.

### CROSS-REFERENCE TO PRIOR APPLICATION

Priority is claimed to U.S. Provisional Patent Application No. 63/112,182 filed on Nov. 11, 2020, the entire contents of which is hereby incorporated by reference herein.

### FIELD

The present invention relates to a method, system and computer-readable medium for fine-grained indoor temperature measurements, in particular usable in a Building Management System (BMS), for improved indoor climate and energy savings, and to a BMS utilizing such method, system and/or computer-readable medium.

### BACKGROUND

Klepeis, Neil E., et al., “The National Human Activity Pattern Survey (NHAPS): a resource for assessing exposure to environmental pollutants,” Journal of Exposure Science & Environmental Epidemiology 11, no. 3, pp. 231-252 (2001) have determined that people in developed countries spend most of their time (>90%) inside buildings, either in residential homes or in non-residential buildings such as office buildings, plants and other workplaces.

In office buildings, technical systems are used for temperature control, which in turn affects the resulting thermal comfort of occupants and connected energy usage. The heating, ventilation and cooling (HVAC) systems that often control the related building parameters is usually the main consumer of energy in a building. Gynther, Lea, et al., “Energy efficiency trends and policies in the household and tertiary sector,” An analysis based on the ODYSSEE and MURE databases (2015) have determined that buildings themselves account for 40% of all consumed energy in developed countries. As such, the efficient operation of the technical systems of buildings, for example, for temperature control, can result in large energy savings and a reduction of carbon emissions. Further, Kosonen, Risto, et al., “Assessment of productivity loss in air-conditioned buildings using PMV index,” Energy and buildings 36, no. 10, pp. 987-993 (2004) have found that thermal comfort is a key factor for content, productive employees. By providing for not only efficient, but also fine-grained and dynamic temperature measurements for temperature control, even further improvements can be achieved. For example, Kingma, Boris, et al., “Energy consumption in buildings and female thermal demand,” Nature Climate Change 5, no. 12, pp. 1054-1056 (2015) have shown that the requirements for thermal comfort differ greatly between individuals and different groups (e.g., women usually prefer a higher temperature than men).

### SUMMARY

In an embodiment, the present invention provides a method for fine-grained indoor temperature measurement. Sensor data and activity telemetry data is received from one or more smart devices. Feature transformation is performed on the sensor data and activity telemetry data to a common latent feature space so as to reduce an influence of a domain of the one or more smart devices. Latent features resulting from the feature transformation on the sensor data and activity telemetry data is input into a machine learning model trained with features of the latent feature space and labeled ambient temperatures to predict an ambient temperature at a location of the one or more smart devices.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates the overall working of a method and system for ambient temperature prediction according to an embodiment of the present invention;

FIG. 2 schematically illustrates knowledge extraction from different data schemas for input into a machine learning (ML) model according to an embodiment of the present invention;

FIG. 3 schematically illustrates the a method and system for ambient temperature prediction system is used in conjunction with a BMS to achieve optimized building operation according to an embodiment of the present invention;

FIG. 4 schematically illustrates a combination of predicted temperature with a mobile app for capturing user preferences according to an embodiment of the present invention; and

FIG. 5 schematically illustrates a method and user device which can be used in a privacy-preserving manner to predict ambient temperature according to an embodiment of the present invention.

### DETAILED DESCRIPTION

The technical control systems of many buildings are not currently efficient which results in wasting energy, and associated costs, and causes increased carbon emissions, as well as occupant discomfort and lower productivity. Embodiments of the present invention provide for improving these technical control systems so that they are more efficient. An important tool provided in embodiments of the present invention which allows for a more efficient technical operation of a thermal control system is the ability to make fine-grained temperature measurements, on a per room level or even for multiple zones per room.

Embodiments of the present invention provide, a method, system and computer-readable medium for fine-grained indoor temperature measurements, utilizing ubiquitous smart devices, such as smartphones and laptops, readily available in most buildings to achieve more efficient technical operation of a building's thermal control systems, thereby providing higher thermal comfort and energy savings, and the other improvements discussed above. Embodiments of the present invention can be applied to improve a building's existing technical control systems, such as by integrating with a BMS. Embodiments of the present invention provide for such fine-grained indoor temperature measurements by training a machine learning model that learns the complex correlations between internal smart device sensors (e.g., various temperature sensors, fan speeds, etc.), activity telemetry data (e.g., central processing unit (CPU), disk, memory load, number active of processes, etc.) and the ambient indoor temperature from a transformed feature space that enables the easy transfer of a trained model between different devices, such as different laptop makes, and different environments, such as surface materials.

The inventors have recognized that many currently deployed BMSs have too coarse temperature sensor deployments. Data might not be easily available or accessible due to the systems being older and outdated. One solution to this problem which has been used in the past is to deploy additional Internet of Things (IoT) devices, in particular extra sensor nodes, in every room. The problem with these approaches is that they cost additional money for installation and maintenance (e.g., battery replacements) and involve organizational effort because buildings might be owned by different entities than they are used by and installation of additional fixed sensing infrastructure might be prohibitive.

Compared to existing approaches, embodiments of the present invention to improve the technical systems of buildings to achieve more accurate temperature measurements and control are relatively inexpensive, seamless to deploy everywhere without much effort and fit to the common setting of user-bound smart devices (e.g., laptops, smartphones, tablets, etc.). Embodiments of the present invention utilize internal sensors of occupants' smart devices (e.g., internal temperature sensors, fan speeds, etc.) together with activity telemetry data (e.g., CPU, disk, memory load, number active of processes, etc.) as features in a machine learning model that learns the relation of these values and the actual ambient temperature. In particular, it was discovered in the present invention that device internal sensors and telemetry data have an unknown relation to the ambient temperature, which relation can be learned according to embodiments of the present invention. A number of data points can effect temperature (e.g., lid closed, charging status, fan speed, etc.), and these data points can be used to train the model that can predict ambient temperature.

Besides a seamless, fine-grained indoor temperature prediction, embodiments of the present invention also enable to automatically localize smart devices inside the building (and thus the location of the virtual temperature sensor) using wireless signals, for example wireless signals of readily available technologies (e.g., Wi-Fi and Bluetooth).

In an embodiment, the present invention provides a method for indoor temperature measurement. Sensor data and activity telemetry data is received from one or more smart devices. Feature transformation is performed on the sensor data and activity telemetry data to a common latent feature space so as to reduce an influence of a domain of the one or more smart devices. Latent features resulting from the feature transformation on the sensor data and activity telemetry data is input into a machine learning model trained with features of the latent feature space and labeled ambient temperatures to predict an ambient temperature at a location of the one or more smart devices.

In an embodiment, the method further comprises providing the predicted ambient temperature to a Building Management System (BMS) server for a temperature adjustment at the location of the one or more smart devices.

In an embodiment, the BMS server actuates switches or controllers of one or more of a Heating, Ventilation and Air Conditioning (HVAC) system, lights and blinds for the temperature adjustment.

In an embodiment, the method further comprises receiving information indicating a comfort level for the location of the one or more smart devices from a user input in a graphical user interface (GUI) provided by an application installed on the one or more smart devices.

In an embodiment, the method further comprises receiving desired temperature from a user of the one or more smart devices which is used for the temperature adjustment by the BMS server.

In an embodiment, the method is executed on the one or more smart devices such that the predicted ambient temperature is sent to the BMS server without revealing the sensor data and activity telemetry data from the one or more smart devices to the BMS server.

In an embodiment, the latent feature space minimizes a maximum mean discrepancy (MMD) distance between different datasets so as to reduce influence of different thermal conductivity of a different environment of the one or more smart devices as the domain.

In an embodiment, the method further comprises determining a difference between the predicted ambient temperature against an output of a temperature sensor and classifying the temperature sensor as a mal-behaving sensor in a case that the difference exceeds a predetermined threshold.

In an embodiment, the machine learning model is trained using an output of a temperature sensor disposed at the location of the one or more existing smart devices.

In an embodiment, the method further comprises adjusting the predicted ambient temperature using an output data of a temperature sensor.

In an embodiment, the method further comprises aligning the sensor data and activity telemetry data to a schema/ontology of the one or more smart devices, and preferably removing outliers based on the aligned sensor data and activity telemetry data.

In another embodiment, the present invention provides a system for indoor temperature measurement, the system comprising one or more hardware processors which, alone or in combination, are configured to facilitate execution of the following steps: receiving sensor data and activity telemetry data from one or more smart devices; performing feature transformation on the sensor data and activity telemetry data to a common latent feature space so as to reduce an influence of a domain of the one or more smart devices; and inputting latent features resulting from the feature transformation on the sensor data and activity telemetry data into a machine learning model trained with features of the latent feature space and labeled ambient temperatures to predict an ambient temperature at a location of the one or more smart devices, or the steps of any method according to an embodiment of the present invention.

In an embodiment, the one or more hardware processors are one or more hardware processors of the one or more smart devices which are configured to communicate the predicted ambient temperature to a BMS server for a temperature adjustment at the location of the one or more smart devices.

In an embodiment, the one or more hardware processors are one or more hardware processors of a BMS server configured to provide a temperature adjustment at the location of the one or more smart devices at the location of the one or more smart devices using the predicted ambient temperature.

In a further embodiment, the present invention provides a tangible, non-transitory computer-readable medium having instructions thereon, which upon execution by one or more processors, facilitate performance of the steps of any method according to an embodiment of the present invention.

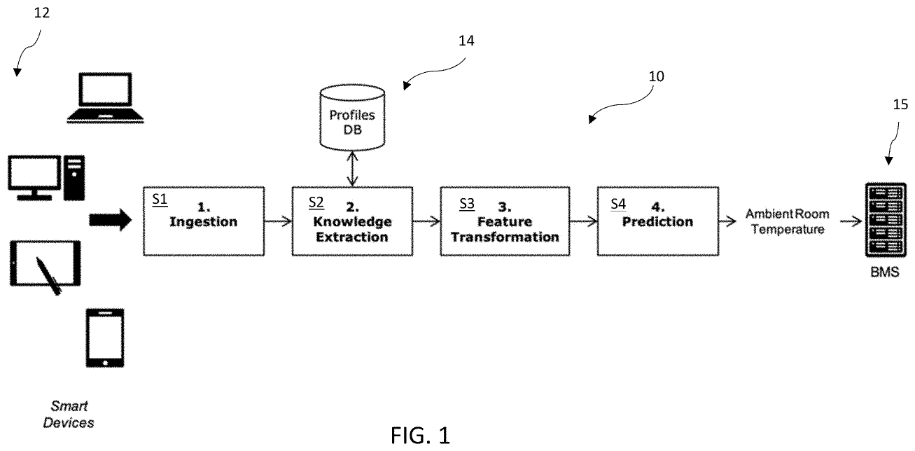

FIG. 1 schematically illustrates a method and an ambient temperature prediction system 10 in accordance with embodiments of the present invention to predict ambient temperature from sensors and activity telemetry data of smart devices 12. In the ingestion step S1, sensors and activity telemetry data are obtained through an executable placed on the smart devices 12. In the knowledge extraction step S2, data is then extracted, preprocessed and aligned to standardized hierarchy of data models (e.g., defined schemas) using a profiles database (DB) 14, and defined for different types of smart devices (e.g., a generic laptop model with a children class of a specific laptop model). In the feature transformation step S3, the features are transformed to a latent feature space to mitigate the thermal effect of different surface materials on the data distributions (e.g., wooden desk vs. aluminum laptop stand). In the prediction step S4, these latent features are used as input for a machine learning model that predicts the ambient room temperature. The predicted room temperature is used as input for the BMS 15 and can be used to optimize actuations of the HVAC systems in the building.

In the following further information on the steps S1-S4 of FIG. 1 is provided.

### Step S1: Ingestion

For the ingestion step S1, an application is installed and runs on the user's smart device to ingest data from internal sensors and activity related telemetry. This can be achieved through existing application programming interfaces (APIs), whereby the information is sent to a server, such as a server of the BMS 15 or another server, for example using a representational state transfer (REST) hypertext transfer protocol (HTTP) interface. Internal sensor data might be from internal temperature sensors (e.g., CPU, graphics processing unit (GPU), memory disk, etc.) of various sensed status information (e.g., fan status, battery status, charging status, lid closed/open, keyboard lighting status, etc.). Activity related telemetry data is any data that is related to the user's and the smart device's activity (e.g., the current processes, the current CPU load of the machine, used random access memory (RAM), disk and network input/outputs (IOs), etc.). The output of this step is a set of key value pairs that define attribute names and attribute values.

### Step S2: Knowledge Extraction and Matching to Device Category Schema/Ontology

There are different smart devices categories (e.g., laptop, desktop, smartphone etc.) and even a device model inside such a category has different sensors available (e.g., different laptop models have different numbers of temperature sensors or fans available). To deal with this heterogeneity, embodiments of the present invention make use of defined device data schemas/ontologies stored in the profiles DB 14 that model different device categories together with more specific sub classes (e.g., down to a specific product). The schemas/ontologies are taxonomies which describe these categories (e.g., laptop category which has a display, a keyboard, a CPU, memory, etc.) with children classes, such as a specific laptop model, which then have more details (e.g., that the model has five temperature sensors and the names and/or specifications of these temperature sensors). The data schemas/ontologies can be modeled after existing, commonly used ones. In particular, multiple generic base types (classes, profiles) are defined for the different categories (e.g., a laptop base type). Such a base type defines the minimum common available sensors and activity telemetry data for this category. For each base type, two more levels of increasingly specific child classes are defined that represent brand instances of a base type (e.g., all laptops from brand ACME) and specific models (e.g., Laptop, Brand ACME, Model X). For the knowledge extraction step S2, when data has been ingested from a new device model, an automated procedure is used to try to match the ingested data to available classes in a database. In some cases it is possible to directly read the device model, for example through associated APIs. If a specific class is not available for a new device model, the available data is extracted and used to map it to the fitting base class, thereby aggregating available data adequately (e.g., multiple available CPU temperature sensor values are aggregated to a single, virtual CPU temperature attribute). Then, based on the now aligned schema, semantic supported data cleaning is performed by removing outliers and values outside the reasonable range of a sensor type (e.g., temperature sensor range must be between 0 and 100 degree Celsius). The output of this step is an aligned dataset that conforms to a generic schema or a model specific schema, and has been cleaned of outliers.

According to an embodiment of the present invention, matching can be based on the data which was possible to gather. For example, the following cases are possible:
Case 1: The exact same laptop model exists in the profiles DB 14. In this case, the sensed data directly is mapped to that model.
Case 2: The profiles DB 14 does not have the exact laptop model, but does have a model which has the same number of sensors. In this case, the sensed data is mapped to that model with the same number of sensors.
Case 3: No match is found based on the sensors that are read. In this case, the sensed data is mapped to the base laptop class, which aggregates multiple sensors.

### Step S3: Feature Transformation

Besides the previously addressed alignment problem and the handling of different device models, another technical challenge addressed by embodiments of the present invention is the influence of various environments on the thermal behavior of a device. For example, the thermal behavior is impacted by the surface where a device is placed (e.g., a laptop on a wooden table, glass table, aluminum laptop stand will show a different behavior and thus different sensor readings for the same ambient temperature). To deal with this issue, an embodiment of the present invention applies a symmetric feature transformation technique in the feature transformation step S3 to project the feature space of different environments to a common latent feature space in order to apply standard machine learning techniques afterwards.

An insight according to an embodiment of the present invention is that thermal behavior is mainly influenced by the surface material and its thermal conductivity. For example, the thermal conductivity λ (defined in

$$\frac{W}{m K} )$$

for a glass table is around 0,76

$$\frac{W}{m K} ,$$

whereas the thermal conductivity of aluminum alloys (commonly used for laptop stands) is between 75 and 235

$$\frac{W}{m K} ,$$

100-fold higher. Such high differences, would make machine learning models trained with the “raw” features only applicable to the environment that they were trained for (i.e., the surface material). Instead, according to an embodiment of the present invention, this surface material influence is correlated with the maximum mean discrepancy (MMD) distance between the source and target material in a given kernel space, so that by minimizing the MMD distance between both distributions, it is advantageously possible to minimize the surface material impact on the thermal behavior.

The MMD distance between two datasets X={x₁, . . . xₙ} and Y={y₁, . . . yₙ} is defined as follows (see Pan, Sinno Jialin, et al., “Transfer learning via dimensionality reduction,” In AAAI, vol. 8, pp. 677-682 (2008), which is hereby incorporated by reference herein):

$$Dist ( X , Y ) = {‖ \frac{1}{{n}_{1}} {\sum }_{i = 1}^{{n}_{1}} ϕ ( {x}_{i} ) - \frac{1}{{n}_{2}} {\sum }_{i = 1}^{{n}_{2}} ϕ ( {y}_{i} ) ‖}_{ℋ} \qquad$$

where:

n₁ and n₂ are the number of data samples in each dataset

xᵢ and yᵢ are the ith samples in both datasets

ϕ is the kernel-induced feature map

[symbol] is norm in the reproducing kernel Hilbert space (RKHS)

This advantageously enables to only have to collect training data once, train a machine learning model for a profile and then use the same model for various surface environments. There are multiple ways to minimize MMD, e.g., by applying maximum mean discrepancy embedding (MMDE) (see, e.g., Pan, Sinno Jialin, et al., “Transfer learning via dimensionality reduction,” In AAAI, vol. 8, pp. 677-682 (2008)) or transfer component analysis (TCA) (see, e.g., Pan, Sinno Jialin, et al., “Domain adaptation via transfer component analysis,” IEEE Transactions on Neural Networks 22, no. 2, pp. 199-210 (2010), which is hereby incorporated by reference herein). In other embodiments of the present invention, other feature-based transfer learning techniques as well as instance-based techniques can also be used if data for the target domain is available.

### Step S4: Prediction (Including Training Phase and Operation Phase)

In the training phase, to train a new model, the latent features are used together with labels (e.g., the ambient temperature obtained, e.g., through a dedicated temperature sensor) to train a machine learning model.

In the operation phase, the transformed features can now be used with the trained machine learning model in order to predict the ambient temperature. Advantageously, as discussed above, due to the feature transformation step, the same model can be used to predict ambient temperatures for multiple environments, such as different surface materials. Through the automated knowledge extraction of step S2 and the hierarchical modeling of smart devices from generic category devices (e.g., laptop type) to specific models (e.g., Brand ACME, Model X) it is possible to now choose the closest, and thereby most precise match:
If the application is later deployed on a device of Brand ACME and Model X, for which an inference model has been trained, this model is used.
If instead the application does not possess an inference model for Model X, but the device belongs to a brand for which there exists a trained model, then the brand model is used.
If no model for the brand and device exists, then a generic model is used.

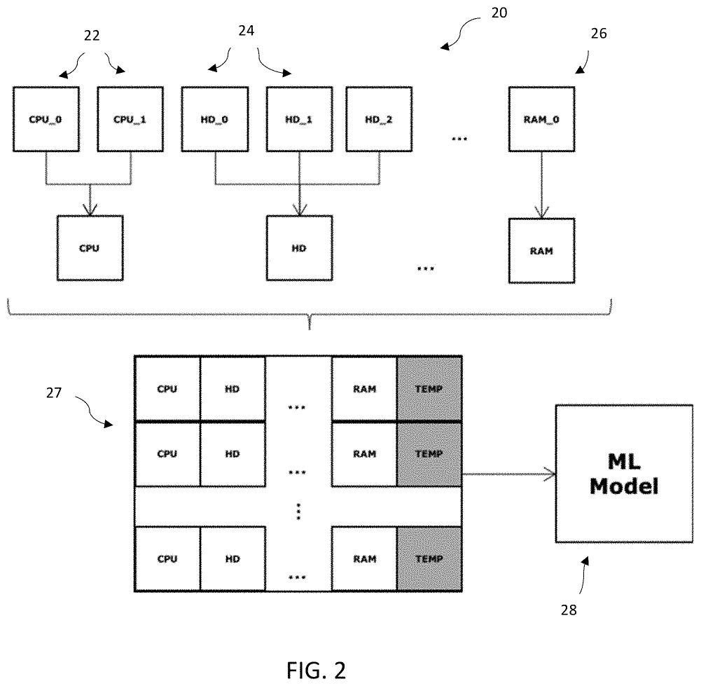

FIG. 2 schematically illustrates a method and system 20 for aligning different sensor and telemetry data schemes, e.g., from different hardware models to a common, more abstract, generic ML model 28. Ideally, there would be a trained ML model for each hardware model, i.e., each laptop model produced. However, in cases where this is not feasible, it is possible to abstract and aggregate to a more generic type. For example, CPUs of a device CPU_0, CPU_1 22; hard drives (HDs) of the device HD_0, HD_1, HD_3 24; and memory devices, such as random access memory (RAM) of device RAM_0 26 can be combined through aggregation and abstracted to be able to use the generic ML model 28. For example, if there are two CPU temperature sensor values of 70° C. and 80° C., this could be aggregated to 75° C. The matrix 27 represents multiple data points that can now be processed by the generic ML model 28.

Thus, according to an embodiment of the present invention, there are multiple trained models. Where there is not a trained model, the closest match in the schema/ontologies can be used, or the generic model. Preferably, complexities of different surfaces are taken into account by feature transformation.

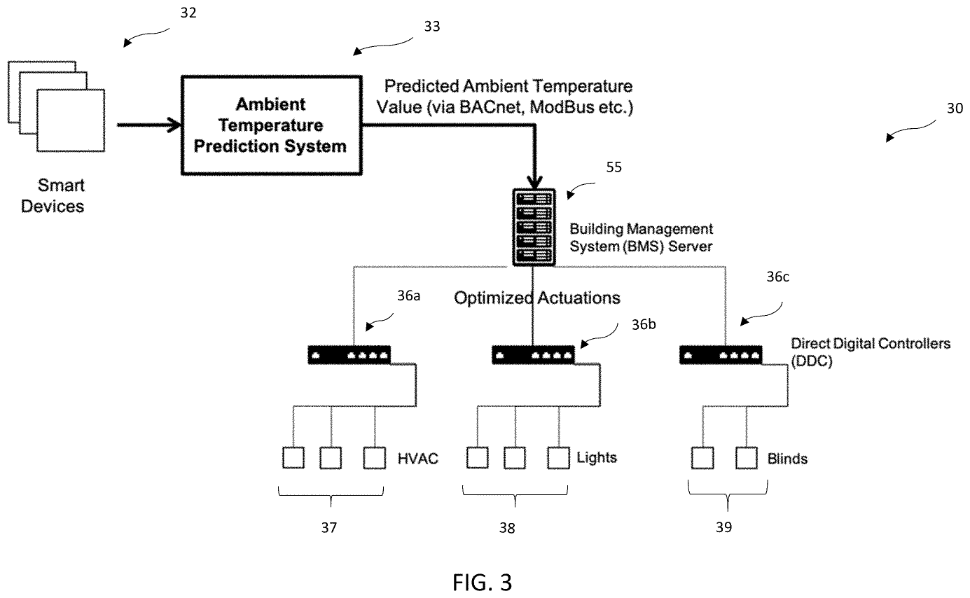

In a first embodiment of the present invention, an ambient temperature prediction system is provided in conjunction with a BMS. FIG. 3 schematically illustrates a method and system 30 implementing such an embodiment. In this embodiment, the predicted room temperature provided using the data from one or more smart devices 32 applied to the ambient temperature prediction 33 in accordance with an embodiment of the present invention can be used in combination with a BMS server 35 to automatically adjust heating and cooling of rooms by activating switches and/or controllers (e.g., direct digital controllers (DDCs) 36a-36c of HVAC systems 37, lights 38 and/or blinds 39). The ambient temperature prediction can be provided to the BMS server 35, for example, using BACnet (a communication protocol for building automation and control networks) or ModBus (a communication protocol for use with programmable logic controllers). The user can input a temperature preference into the one or more smart devices 32 that the BMS server 35 will try to keep in the room where the user and the one or more smart devices 32 are located. If the user moves around the building, as indicated by data from the one or more smart devices 32, the temperature can be adjusted on a per room basis by using the inferred temperature with the location of the one or more smart devices 32.

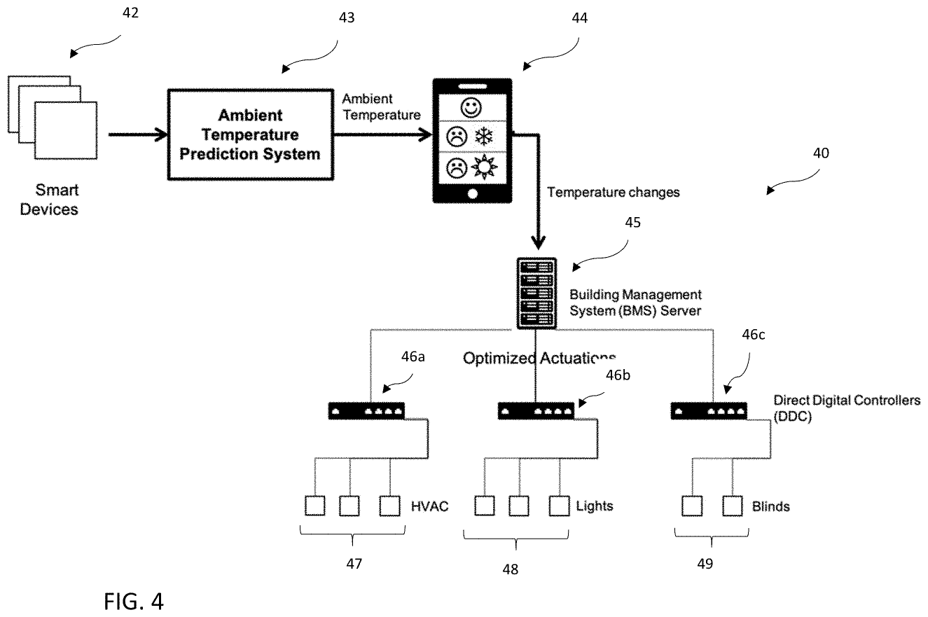

In a second embodiment of the present invention, a combination of predicted temperature with a mobile app for capturing user preferences is provided. FIG. 4 schematically illustrates a method and system 40 implementing such an embodiment. In this embodiment, a basic graphical user interface (GUI) 44 can be used, in which users can input their comfort level (e.g. identifying comfort levels with ratings (e.g., from 1 to 10) or smileys, such as the ones used in airports and other public spaces, or simply with levels “too cold”, “too warm”, “just right”). Users can enter these ratings into such an application on the one or more smart devices 42 they are utilizing, and based on this information, the application and/or another device or server which applies the ambient temperature prediction system 43 in accordance with an embodiment of the present invention will communicate to the BMS server 45 to lower or increase the temperature of the room where the user is currently located from the predicted ambient temperature or based on the predicted ambient temperature together with the user input.

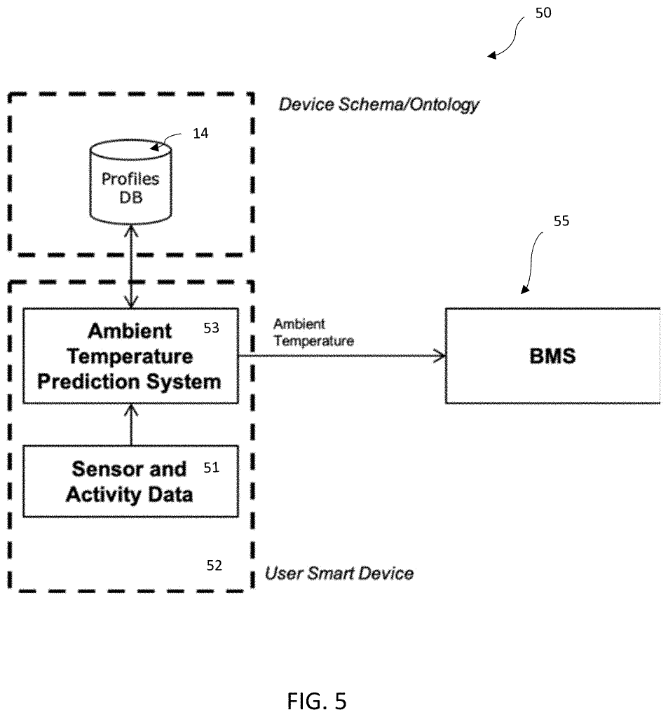

In a third embodiment of the present invention, a local execution can be provided for at the location of the user. FIG. 5 schematically illustrates a method and system 50 including one or more smart devices 52 of a user implementing such an embodiment. In this embodiment, privacy of user data is advantageously ensured. The ambient prediction system 53 according to this embodiment of the present invention can fully run on the one or more smart devices 52 of the user and only send the predicted temperature to the BMS 55, without revealing any user or device data on the one or more smart devices 52 including internal sensors or activity data 51 of the user. For performing the knowledge extraction step S2, the profiles DB 14 (see also FIG. 1) can also be stored locally on the one or more smart devices 52 or accessed remotely by the one or more smart devices 52 at an external server or in the Cloud.

In a first extension of an embodiment of the present invention, the ambient temperature prediction model can also be trained with ground-truth temperature from existing sensors in the building in an opportunistic fashion, e.g., when the user is close to an existing temperature sensor, the system can be trained with that sensor's output as labeled ground-truth. In this case, the initial model is trained in part with the actual data from existing sensors.

In a second extension of an embodiment of the present invention, it is also possible to opportunistically use existing available sensors in order to calibrate a running instance of an embodiment of the present invention. In other words, the existing sensors can be used to correct the predicted temperature from the system. For this, the machine learning model is re-trained using the data from the sensors of the device and the temperature from existing temperature sensors as ground-truth. In this case, there is a trained model (e.g., trained with data from other sensors not currently deployed in the room) for which the existing sensors allow to detect how well the model is working. Based thereon, the model can then be retrained or calibrated.

In a third extension of an embodiment of the present invention, it is further possible to use the method and system according to embodiments of the present invention to detect faulty or improperly-behaving deployed temperature sensors in a building in a simple manner by comparing the output of the prediction according to an embodiment of the present invention to the output of the deployed temperature sensor and classifying it as a faulty or improperly-behaving sensor when the difference is larger than a configurable threshold.

Thus, improvements provided by embodiments of the present invention include the provision of a machine learning-based, fine-grained inference of ambient temperature advantageously using ubiquitous and off-the-shelf device sensors and activity data in order to optimize comfort and energy consumption in buildings, which includes technical solutions to technical challenges providing further improvements such as:
1. Automated alignment and aggregation of heterogeneous device specific data schemas to an interoperable hierarchical device schema/ontology.
2. Minimization of the thermal conductivity impact of different surface materials through a transformation of the features to a latent feature space that minimizes the MMD distance between different data distributions, enabling a simple transfer of trained models.

In an embodiment, the present invention provides a method for fine-grained temperature measurement comprising the following steps:
1. Ingest internal smart device sensors and activity telemetry data.
2. Knowledge extraction, which aligns the data to a hierarchically defined device schema/ontology with a canonical set of attribute dimensions and removes possible outliers, utilizing the achieved semantic understanding.
3. Feature transformation, projecting the feature space of multiple domains to a common latent feature space that minimizes the influence of the domain (e.g., the surface material).
4. Train a machine learning model with the features of the latent feature space and labeled ambient temperature.
5. Input the latent features in the trained machine learning model for predicting the ambient temperature and output the predicted ambient temperature to relevant building control systems, such as a BMS.

In contrast to embodiments of the present invention, known temperature measurement and control systems for buildings require additional costly sensor infrastructure that requires constant maintenance. According to embodiments of the present invention, this additional sensor infrastructure is replaced by a virtual temperature sensor derived from a machine learning model trained with internal sensor data of existing smart devices and activity telemetry data. Further, embodiments of the present invention can be used to automatically localize this virtual temperature sensor inside the building, enabling scenarios where users take their virtual temperature sensors and their thermal preferences with them (e.g., to a meeting room).

Embodiments of the present invention also provide improvements over some other preliminary works using battery temperature of smartphones for outdoor or indoor temperatures in a coarse (i.e., daily average temperature) crowdsourcing approach (see Overeem, Aart, et al., “Crowdsourcing urban air temperatures from smartphone battery temperatures,” Geophysical Research Letters 40, no. 15, pp. 4081-4085 (2013) and Breda, Joseph, et al., “Hot or Not: Leveraging Mobile Devices for Ubiquitous Temperature Sensing,” In Proceedings of the 6th ACM International Conference on Systems for Energy-Efficient Buildings, Cities, and Transportation, pp. 41-50 (2019), each of which is hereby incorporated by reference herein). In particular, in contrast to such works, embodiments of the present invention are able to: 1) predict more accurate ambient temperatures (0.2° C. error in experiments) from a range of sensors and activity telemetry data collected from arbitrary smart devices; 2) perform predictions without delay (e.g., the preliminary work by Breda, Joseph, et al., requires multiple battery temperature readings with a delay in between); and can capture fast temperature changes (e.g., the preliminary work by Breda, Joseph, et al., cannot handle faster temperature changes that often occur if somebody opens a window). These improvements advantageously additionally allow a further improvement to detect occurring faults in a building operation.

Embodiments of the present invention can integrate with an existing BMS and either automatically adapt the BMS parameters to adjust the temperature based on the measurements provided by the predictions according to embodiments of the present invention or enable users to take-over some control by raising their preferences.

Experiments were performed using sensor and telemetry data from a MACBOOK PRO and a high-precision external temperature sensor for ground-truth data collection. The results show the predicted temperature is within 0.2° C. (results from two environments and two laptops), which demonstrates the fine-grained nature of the measurement/prediction according to embodiments of the present invention.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for indoor temperature measurement, the method comprising:
receiving sensor data and activity telemetry data from one or more smart devices;
performing feature transformation on the sensor data and activity telemetry data to a common latent feature space so as to reduce an influence of a domain of the one or more smart devices; and
inputting latent features resulting from the feature transformation on the sensor data and activity telemetry data into a machine learning model trained with features of the latent feature space and labeled ambient temperatures to predict an ambient temperature at a location of the one or more smart devices.

2. The method according to claim 1, further comprising providing the predicted ambient temperature to a Building Management System (BMS) server for a temperature adjustment at the location of the one or more smart devices.

3. The method according to claim 2, wherein the BMS server actuates switches or controllers of one or more of a Heating, Ventilation and Air Conditioning (HVAC) system, lights and blinds for the temperature adjustment.

4. The method according to claim 2, further comprising receiving information indicating a comfort level for the location of the one or more smart devices from a user input in a graphical user interface (GUI) provided by an application installed on the one or more smart devices.

5. The method according to claim 2, further comprising receiving desired temperature from a user of the one or more smart devices which is used for the temperature adjustment by the BMS server.

6. The method according to claim 2, wherein the method is executed on the one or more smart devices such that the predicted ambient temperature is sent to the BMS server without revealing the sensor data and activity telemetry data from the one or more smart devices to the BMS server.

7. The method according to claim 1, wherein the latent feature space minimizes a maximum mean discrepancy (MMD) distance between different datasets so as to reduce influence of different thermal conductivity of a different environment of the one or more smart devices as the domain.

8. The method according to claim 1, further comprising determining a difference between the predicted ambient temperature against an output of a temperature sensor and classifying the temperature sensor as a mal-behaving sensor in a case that the difference exceeds a predetermined threshold.

9. The method according to claim 1, wherein the machine learning model is trained using an output of a temperature sensor disposed at the location of the one or more smart devices.

10. The method according to claim 1, further comprising adjusting the predicted ambient temperature using an output of a temperature sensor.

11. The method according to claim 1, further comprising aligning the sensor data and activity telemetry data to a schema/ontology of the one or more smart devices.

12. A system for indoor temperature measurement, the system comprising one or more hardware processors which, alone or in combination, are configured to facilitate execution of the following steps:
receiving sensor data and activity telemetry data from one or more smart devices;
performing feature transformation on the sensor data and activity telemetry data to a common latent feature space so as to reduce an influence of a domain of the one or more smart devices; and
inputting latent features resulting from the feature transformation on the sensor data and activity telemetry data into a machine learning model trained with features of the latent feature space and labeled ambient temperatures to predict an ambient temperature at a location of the one or more smart devices.

13. The system according to claim 12, wherein the one or more hardware processors are one or more hardware processors of the one or more smart devices which are configured to communicate the predicted ambient temperature to a Building Management System (BMS) server for a temperature adjustment at the location of the one or more smart devices.

14. The system according to claim 12, wherein the one or more hardware processors are one or more hardware processors of a Building Management System (BMS) server configured to provide a temperature adjustment at the location of the one or more smart devices at the location of the one or more smart devices using the predicted ambient temperature.

15. A tangible, non-transitory computer-readable medium having instructions thereon, which upon execution by one or more processors, facilitate performance of the following steps:
receiving sensor data and activity telemetry data from one or more smart devices;
performing feature transformation on the sensor data and activity telemetry data to a common latent feature space so as to reduce an influence of a domain of the one or more smart devices; and
inputting latent features resulting from the feature transformation on the sensor data and activity telemetry data into a machine learning model trained with features of the latent feature space and labeled ambient temperatures to predict an ambient temperature at a location of the one or more smart devices.
